(19) United States
(12) Patent Application Publication
(10) Pub. No.: US 2024/0020169 A1
(43) Pub. Date: Jan. 18, 2024

(54) CONSERVING COMPUTING RESOURCES FOR MACHINE LEARNING PIPELINES WITH A FEATURE SERVICE

(71) Applicant: VMware, Inc., Palo Alto, CA (US)

(72) Inventors: Anthony FENZL, Mountain View, CA (US); Vinith PODDUTURI, Freemont, CA (US); Tejas Sanjeev PANSE, San Jose, CA (US); Karen HAYRAPETYAN, Fremont, CA (US)

(21) Appl. No.: 17/867,427

(22) Filed: Jul. 18, 2022

(51) Int. Cl. G06F 9/50; G06F 12/123

(52) U.S. Cl. CPC G06F 9/5044; G06F 12/123; G06F 2212/45

(57) ABSTRACT

The disclosure herein describes managing the execution of ML pipelines based at least in part on a dependency graph using a feature service. A plurality of feature creator processes are scheduled for execution using a set of feature creation resources. The scheduling is based at least in part on a dependency graph which describes dependency relationships between the plurality of feature creator processes and raw data sets stored in a raw data cache. The scheduled feature creator processes are then executed, wherein feature sets are created from the executed feature creator processes. The features sets are stored in a feature cache and the stored feature sets are exposed to a feature consumer using a feature interface. The use of the dependency graph and the raw data and feature caches enables the disclosure to reduce duplicated effort and resource usage across multiple pipelines that are executed on the system.

### BACKGROUND

In modern computing systems, many different services leverage Machine Learning (ML) to discover insights about those services. ML pipelines are used to create models that can provide such insights when given input data. However, the creation of such models is computationally expensive and complex. In computing systems that are configured to execute ML pipelines, many different pipelines may be executed at once, requiring substantial processing, memory, and data storage resources.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computerized method for managing the execution of ML pipelines based at least in part on a dependency graph using a feature service is described. A plurality of feature creator processes are scheduled for execution using a set of feature creation resources. The scheduling is based at least in part on a dependency graph which describes dependency relationships between the plurality of feature creator processes and raw data sets stored in a raw data cache. The scheduled feature creator processes are then executed, wherein feature sets are created from the executed feature creator processes. The features sets are stored in a feature cache and the stored feature sets are exposed to at least one feature consumer using a feature interface.

### BRIEF DESCRIPTION OF THE DRAWINGS

The present description will be better understood from the following detailed description read in light of the accompanying drawings, wherein:

FIG. 1 is a block diagram illustrating a system configured to manage execution of machine learning (ML) pipelines on a computing platform;

FIGS. 2A-B are diagrams illustrating differences between a system in which ML pipelines are processed separately and a system as described in FIG. 1;

FIG. 3 is a flowchart illustrating a method for managing the execution of ML pipelines in a system based on a dependency graph;

FIG. 4 is a flowchart illustrating a method for scheduling the execution of feature creator processes in a system based on a dependency graph;

FIG. 5 is a flowchart illustrating a method for maintaining up-to-date raw data sets in a raw data cache using update time intervals;

FIG. 6 is a flowchart illustrating a method for updating a system to include a new ML pipeline; and

FIG. 7 illustrates an example computing apparatus as a functional block diagram.

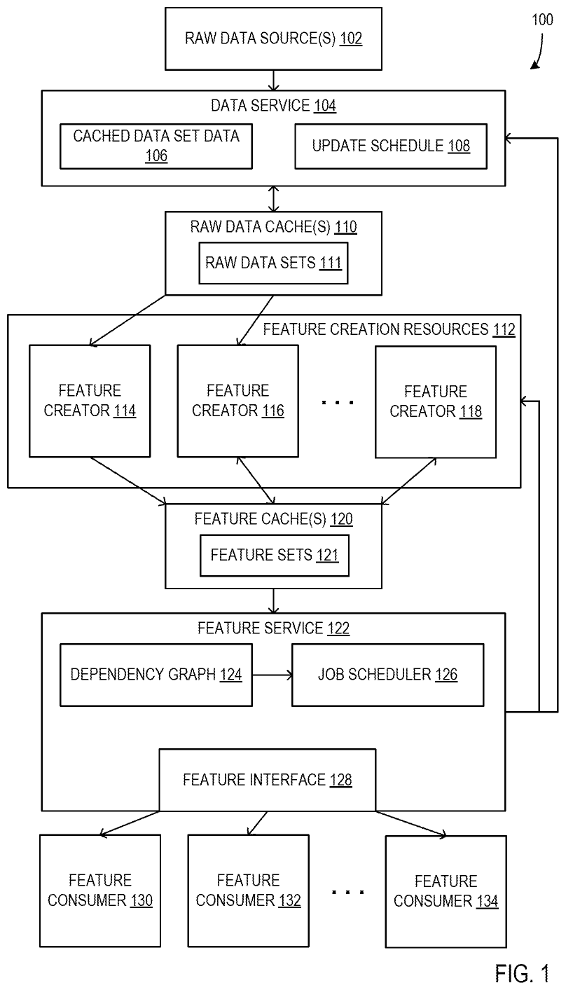

Corresponding reference characters indicate corresponding parts throughout the drawings. In FIGS. 1 to 7, the systems are illustrated as schematic drawings. The drawings may not be to scale.

### DETAILED DESCRIPTION

Aspects of the disclosure provide a computerized method and system for conserving computing resources while managing the execution of machine learning (ML) pipelines in a computing system based at least in part on a dependency graph and utilizing a feature service. The disclosure describes a feature service that schedules data service and feature creator processes based on the dependencies of those processes, which are defined in a dependency graph. The scheduling is done in such a way as described herein to enhance, optimize, or otherwise improve the efficiency of computing resource usage and to reduce or eliminate duplicated effort by the multiple pipelines. The scheduled processes are then executed, including feature creator processes, which create feature sets. The feature sets are stored in a feature cache and those cached feature sets are then provided for use by other feature creator processes and/or exposed to feature consumers by a feature interface. The disclosure provides a flexible yet powerful framework for data scientist and engineers alike. It provides centralized orchestration for minimal reuse of both data and computational resources, a powerful graph representation of dependencies, multiple caching layers for optimized performance when querying, and distributed containerized execution for maximum flexibility in creating feature logic. Downstream dependents and consumers leverage these improvements by calling an application programming interface (API) from a centralized server layer and receiving any needed features quickly and in a computationally efficient manner.

The disclosure operates in an unconventional manner at least by including a shared feature service that is configured to reduce or eliminate duplicated effort associated with creating and executing ML pipelines, including the execution of feature creator processes associated therewith. Duplicated effort not only on the engineering side, to design and build the feature creation pipelines, but also on the computational side, as the results of many steps between features are reused.

The disclosure improves upon the process of loading raw data for use by ML pipelines by enabling raw data sets that have been obtained from raw data sources to be shared among different ML pipelines, rather than requiring each pipeline to perform its own raw data loading processes. The use of the data service and raw data cache as described herein enables the disclosure to avoid duplicating effort and resource use associated with each pipeline performing the same or similar raw data loading operations multiple times. In some examples, the data used by such ML pipelines can be in quantities of gigabytes (GB) and enabling the data to be shared provides significant savings of resources and time for the system. Further, such duplicated processing and/or effort of this type can cause unnecessary load and strain on the database systems of the raw data sources, potentially degrading the performance of other application operations that rely on the same data, so the disclosure provides improved performance for those systems as well.

The disclosure improves the computational efficiency (e.g., computing, storage, and/or bandwidth) of use of feature creation resources and time associated with such processes. The disclosed feature service is configured to efficiently schedule the execution of feature creator processes for multiple pipelines based on the known dependencies of these processes, such that the use of available feature creation resources can be maximized without overloading the system. This scheduling can include the parallel scheduling of feature creator processes when sufficient resources are available. Because the feature service is configured to control the execution of all pipelines on the system, the processes of such pipelines can be assigned to any nodes within the system and/or migrated between nodes to improve efficiency, rather than individual pipelines being assigned static sets of resources that only they can use. In some such examples, the feature service is configured to take advantage of native tooling (e.g., in Kubernetes) to enable these features.

Further, the disclosure is configured to cache created feature sets and enable those cached feature sets to be used by any feature creators or consumers of the system. By enabling such feature set sharing, the disclosure reduces the time and computing resource costs associated with each pipeline creating duplicate feature sets that are needed for their execution.

The disclosure is further configured to manage the complex dependencies between features and the data they consume by defining a dependency graph (e.g., a directed acyclic graph (DAG)) between data sources and feature creators. This allows the disclosure to understand the relationship between feature creators and the data they need. Most importantly, the disclosure can use this dependency graph to identify where multiple feature creators depend on the same data or on each other. The job scheduler can then use this dependency graph to intelligently schedule jobs for the data service and feature creators. Using this dependency graph, the disclosure is configured to reduce or minimize duplicate work across multiple complex dependencies and steps. Without a graph of this nature, entire feature sets would need to be recreated given certain circumstances, and data would be duplicated across pipelines.

Further, the disclosure improves the efficiency of loading raw data and managing created feature sets by introducing two layers of caching: the raw data cache and the feature cache. The raw data cache caches the full sets of data that any feature creator needs, and the data stored in the raw data cache is updated incrementally, such that large quantities of data are not reloaded every time the data is updated. By using the raw data cache in this manner, the computational performance of all feature creator processes is improved due to availability of the required raw data, and the data request load is reduced for the databases of the raw data sources.

The feature cache also enables the disclosure to incrementally update some feature sets in order to further avoid duplicating feature creation time and computing resources effort when possible. The feature sets in the feature cache can be updated in a similar manner to the raw data sets in the raw data cache to achieve improved computational efficiencies with respect to feature creation as described herein.

In addition to performance, the disclosure is configured to enable interoperability when managing ML pipelines. For example, in ML in particular, the support for implementing feature creators in multiple programming languages is important. Many industry standard ML and data science libraries are PYTHON-based, while at the same time other developers might prefer writing in JAVA, GO, or the like. To accommodate multiple languages, in some examples, the disclosure is configured to run all feature creator and data service processes and/or jobs in their own container and use container orchestration logic to manage the creation and scheduling ofjobs. A separate container serves as the server and manages API requests. Since each feature creator runs in its own container, the logic inside can be written in any language. Another advantage of having a container per job is that the disclosure can scale the resource requirements of each container to match the size of the job. If everything ran in one container, the system would have to scale the container for peak load, yet most of the time the assigned resources would remain idle in-between job runs. Further, separating jobs into their own containers allows the scheduling of jobs on any node in the cluster.

FIG. 1 is a block diagram illustrating a system 100 configured to manage execution of ML pipelines. In some examples, the system 100 is a computing platform that includes a data service 104, a raw data cache 110, feature creation resources 112, a feature cache 120, and a feature service 122. The system 100 is configured to obtain raw data from raw data sources 102 and to provide feature sets 121 to feature consumers 130, 132, and/or 134.

In some examples, the system 100 includes three parts or modules: the data service 104; the feature creators 114, 116, and/or 118; and the feature service 122. The data service 104 is configured for loading data into a raw data cache 110 and/or memory. In some examples, the data service 104 is optimized for handling large quantities of data and is configured to be flexible enough to load data in a single threaded asynchronous job, a multi-threaded job on a single host or, for larger tasks, to trigger a spark job or the like to manage data loading. The feature creators 114, 116, and/or 118 are configured for reading in raw data from the raw data cache 110 and performing any steps necessary to convert the raw data into the feature sets 121 as described herein. The feature service 122 is configured to provide a central API layer that serves the feature sets 121 from the feature caches 120 to the feature consumers 130, 132, and/or 134.

Further, in some examples, an ML pipeline includes a series of four steps. The first step is pulling all the data that the model will consider into memory (e.g., obtaining a raw data set 111 in the raw data cache 110). This alone is a large effort as often the success of an ML model depends on considering gigabytes of data. A cluster of multiple physical machines are often needed to share the load. The second step is creating features out of this raw data (e.g., creation of a feature set 121 by a feature creator 114). This step cleans and preprocesses the data before feeding it into the main ML model. While this can include removing some columns or specific values from the data, in modern ML pipelines used in production systems this often includes a complex process in its own right. In some cases, after cleaning and basic preprocessing, a neural network is used to discover an even richer set of features. Additionally, many different ML and statistical analysis techniques can be used to create features or other insights that are valuable to downstream ML consumers (e.g., feature consumers 130, 132, and/or 134). The third step is to train the model, running it over the set of data that was just preprocessed. The components that train the model are feature consumers as described herein. Lastly, the model is used for prediction. The described systems and methods are primarily directed to the steps of obtaining the raw data, creating the feature sets, and providing those feature sets to the feature consumers, which may be configured to train and/or use models based at least in part on the created feature sets.

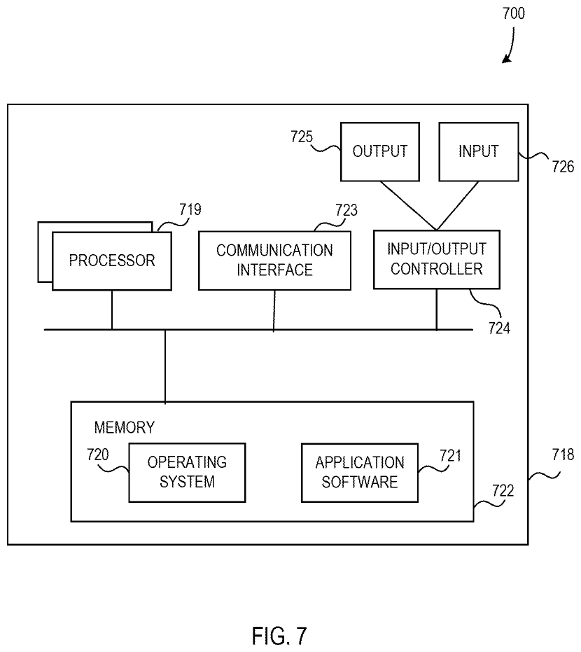

In some examples, the system 100 includes a computing device (e.g., the computing apparatus of FIG. 7). Further, in some examples, the system 100 includes multiple computing devices that are configured to communicate with each other via one or more communication networks (e.g., an intranet, the Internet, a cellular network, other wireless network, other wired network, or the like). In some examples, the system 100 includes a plurality of node computing devices connected by one or more networks to form a cluster. Additionally, or alternatively, the system 100 includes one or more virtual computing instances (VCIs), such as virtual machines (VMs), containers, or the like, which are executed on one or more computing devices of the system 100. In some examples, the ML pipelines that are executed in the system 100 are located on and/or executed on one or more computing devices of the system 100 and/or on one or more VCIs of the system 100 without departing from the description. Further, in some examples, the data service 104, raw data cache 110, feature creation resources 112, feature cache 120, and/or feature service 122 are configured to be located on and/or executed on one or more of the computing devices of the system 100 and/or one or more of the VCIs of the system 100 without departing from the description. For example, a feature service 122 is stored on and executed on a first computing device of the system 100 and a data service 104 is stored on and executed on a second computing device of the system 100. The feature creation resources 112 of the system 100 may be located on one computing device and/or distributed across multiple computing devices of the system 100 without departing from the description.

Further, in some examples, the raw data source(s) 102 include computing devices and/or other data storage entities that store raw data. At least a portion of the stored raw data in the raw data sources 102 is required for feature creator processes, such as feature creators 114, 116, and/or 118, to complete feature creation operations. In some examples, the raw data sources 102 store the raw data in databases or other data structures. Further, the raw data sources 102 are configured to communicate with the data service 104 and enable the data service 104 to obtain raw data for storage in the raw data cache(s) 110 as described herein. Additionally, or alternatively, raw data sources 102 include data sources that are used to collect raw data associated with the operation of the system 100, a related system, and/or another entity (e.g., a raw data store that stores raw data associated with a customer entity for whom ML pipelines are being executed).

The data service 104 includes hardware, firmware, and/or software configured to obtain raw data from the raw data sources 102 and to store obtained raw data to the raw data caches 110 so that it can be used by the feature creators 114, 116, 118, and/or other feature creator processes. In some examples, the data service 104 includes cached data set data 106 and an update schedule 108. The cached data set data 106 includes data that is indicative of the raw data sets 111 that are currently stored in the raw data caches 110 and/or data that is indicative of the raw data sets 111 that the data service 104 should obtain from the raw data sources 102 for storage in the raw data caches 110. For example, the raw data caches 110 include raw data sets A, B, and C. The cached data set data 106 of the data service 104 includes identifiers for each of the raw data sets A, B, and C enabling the data service 104 and/or other entities such as feature creator processes to identify the raw data sets 111 that are cached in caches 110. Additionally, or alternatively, the cached data set data 106 includes storage location information associated each of the raw data sets A, B, and C. The storage location information enables the data service 104 to determine the location of the raw data sets A, B, and C in the raw data sources 102. The data service 104 is configured to obtain the raw data sets 111 based on the storage location information.

Additionally, or alternatively, changing the cached data set data 106 causes the data service 104 to change the stored raw data sets 111 in the raw data caches 110 to match. For example, data associated with a raw data set D is added to the cached data set data 106 and, based at least in part on the added data, the data service 104 locates and obtains the raw data set D from the raw data sources 102 and stores the raw data set D in the raw data caches 110. Further, in another example, the data associated with raw data set B is removed from the cached data set data 106 and, based at least in part on removing the data, the raw data set B is removed from the raw data caches 110 or the space occupied by the raw data set B is otherwise freed. For example, the space of the raw data set B is flagged for overwriting, such that the data of the raw data set B is overwritten when that space is needed.

Further, in some examples, the data service 104 is configured to keep the cached raw data sets 111 up-to-date based at least in part on an update schedule 108. The update schedule 108 includes data that defines how the raw data sets 111 are updated using raw data from the raw data sources 102 and/or how often the raw data sets 111 are updated. For example, a raw data set 111 includes 30 days' worth of raw data and the raw data set 111 is configured to be updated every day with raw data collected on or otherwise associated with the most recent day. The update schedule 108 is configured to indicate that this raw data set 111 is to be updated each day (e.g., at a particular time), such that the data service 104 is configured to obtain the raw data of the most recent day from the raw data sources 102 (e.g., based at least in part on cached data set data 106). The data service 104 is further configured to use the obtained data to update the raw data set 111 such that it includes the raw data of the most recent day. Additionally, in some examples, the raw data set 111 is defined as always including only 30 days of data, such that the raw data of the raw data set 111 that is associated with the oldest day-long period is deleted or otherwise removed from the raw data set 111.

In other examples, other methods of scheduling updates for raw data sets 111 are used with the update schedule 108 without departing from the description. For example, the update schedule 108 for a raw data set 111 is configured such that the raw data set 111 is updated when all the feature creators and/or other entities that consume the raw data set 111 have consumed the current version of the raw data set 111. In such examples, the feature service 122 or other entity of the system 100 notifies the data service 104 when a current version of the raw data set 111 has been consumed by all determined consumers and, as a result of the notification, the data service 104 initiates operations to update the raw data set 111 as described herein.

The raw data cache or caches 110 are configured to store raw data sets 111 as described herein. In some examples, the raw data cache 110 is a single cache, while in other examples, the raw data caches 110 include multiple caches. Further, the raw data caches 110 are configured to enable feature creators 114, 116, and/or 118 to obtain or otherwise access the stored raw data sets 111 more quickly and efficiently than obtaining or accessing the same data from a raw data source 102. In some examples, the raw data caches 110 are located on a computing device or devices within the system that are configured to specifically respond to data requests from feature creators 114, 116, and/or 118. In contrast, obtaining data from raw data sources 102 requires establishing communications with raw data sources 102 via communication networks outside of the system 100 and waiting on a response from the raw data sources 102, which are not configured for specifically serving data to the feature creators of system 100.

The feature creation resources 112 include hardware, firmware, and/or software that are configured for use by feature creator processes, including feature creators 114, 116, and/or 118, to create feature sets 121 from raw data sets 111. Additionally, in some examples, some features sets 111 are created by feature creators from other feature sets 111. The feature creation resources 112 may include one or more computing devices and/or associated processing resources, such as accelerator devices (e.g., graphics processing units (GPUs)). The feature creators 114, 116, and/or 118 are configured to process data of the raw data sets 111 to create feature sets 121 according to defined rules or associated processes. For example, a feature creator 114 obtains a raw data set 111, which includes a set of data entries with multiple data values (e.g., rows of data in a data table with multiple columns for different types of data values). The feature creator 114 is configured to filter out data entries of the raw data set 111 that have empty or missing data values in order to ensure that all data entries contain complete information. Additionally, or alternatively, the feature creator 114 is configured to remove columns from the data entries in the resulting data set, and/or data entries from multiple data sets are combined into a single data set. The resulting filtered or otherwise modified data set is stored in a feature cache 120 as a feature set 121. It should be understood that, in some examples, feature creation processes include completely transforming raw data into feature data that is very different from the raw data. For example, feature creation, feature extraction, and/or feature discovery includes processes using domain knowledge to extract features (e.g., characteristics, properties, and/or attributes of data) from raw data. In some examples, such feature creation processes include numerical transformation (e.g., multiplying data by fractions or scaling data values up or down), category encoding like one-hot or target encoding, clustering of data, grouping of aggregated data values, principal component analysis, or the like.

Additionally, or alternatively, in some examples, a feature creator 116 uses one or more raw data sets 111 and/or one or more feature sets 121 to create another feature set 121. In an example, the feature creator 116 includes a trained feature creator model that analyzes the input data and generates a set of encoded data values that are then stored in a feature cache 120 as a feature set 121.

In other examples, other types of feature creator processes are used. The feature creators 114, 116, and/or 118 may be configured to create feature sets 121 using any methods used in ML pipelines without departing from the description.

The feature service 122 includes hardware, firmware, and/or software configured to provide feature sets 121 to feature consumers (e.g., feature consumers 130, 132, and/or 134). Further, in some examples, the feature service 122 is configured to use a dependency graph 124 and a job scheduler 126 to manage the operations of the data service 104 and the feature creation resources 112 in an efficient manner as described herein. It should be understood that, while the feature service 122 is illustrated as including the dependency graph 124 and job scheduler 126, in other examples, the dependency graph 124 and/or job scheduler 126 components are located on and/or associated with one or more other entities of the system 100 or otherwise separated from the feature service 122 entity.

In some examples, the feature service 128 further includes a feature interface 128 that is configured to communicate with the feature consumers to provide those consumers with the feature sets 121 that are needed to complete their ML pipeline operations. Feature consumers 130, 132, and/or 134 may be configured to use, or consume, feature sets 121 during performance of ML operations, such as training operations for training ML models, such as deep learning models.

In some examples, each feature creator and feature consumer has a set of dependencies upon which they depend in order to perform the operations for which they are configured. A feature creator 116 may depend on one or more raw data sets 111 and/or one or more feature sets 121 to create an associated feature set 121. In another example, a feature consumer 130 depends on one or more feature sets 121 that have been created by one or more of the feature creators 114, 116, and/or 118. In such examples, the raw data set 111 or feature set 121 that a feature creator or feature consumer depends on is a dependency of that entity (e.g., feature creator 114 has a raw data set 111 as a dependency).

The dependency graph 124 is defined to include the dependencies of all the current feature creators and feature consumers in the system 100. In some examples, the dependency graph 124 is configured as a DAG, but in other examples, other types of graphs are used without departing from the description.

The feature service 122 is configured to analyze the dependency graph 124 in order to schedule the operations of the data service 104 and the feature creators using the job scheduler 126. For example, the dependency graph 124 includes information that indicates all the raw data sets upon which the feature creators of the system depend. Based at least in part on this information in the dependency graph 124, the job scheduler 126 instructs the data service 104 as to which raw data sets 111 are to be obtained from raw data sources 102. Further, in some examples, the job scheduler 126 instructs the data service 104 as to when each raw data set 111 is to be obtained and/or in what order the raw data sets 111 are to be obtained from the raw data sources 102. In some examples, the data service 104 is instructed to obtain a raw data set 111 first if it is a dependency of a feature creator that will be executed soon, while the data service 104 is instructed to obtain another raw data set 111 later if it is only a dependency of another feature creator that will be executed later in the process. For example, the second feature creator is also dependent on the first feature creator and so it cannot execute until the first feature creator process is complete.

The job scheduler 126 may be configured to instruct the feature creation resources 112 as to when and/or in what order to execute the feature creators 114, 116, and/or 118 based at least in part on the dependency graph 124. For example, the feature creator 116 has a dependency that is a feature set 121 that is created by the feature creator 114. Based at least in part on this dependency, the job scheduler 126 schedules the feature creator 114 to be executed before the feature creator 116 is executed, such that the feature set 121 created by the feature creator 114 is available for use by the feature creator 116.

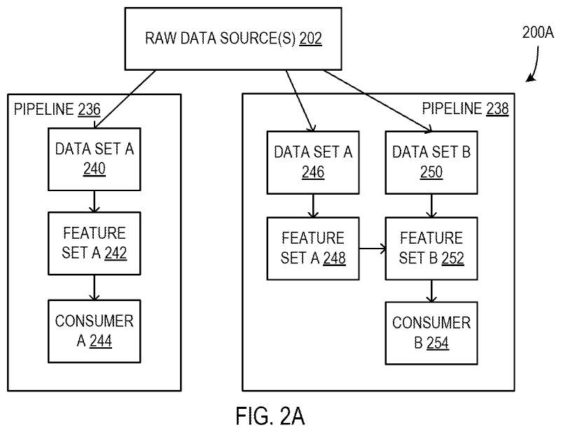

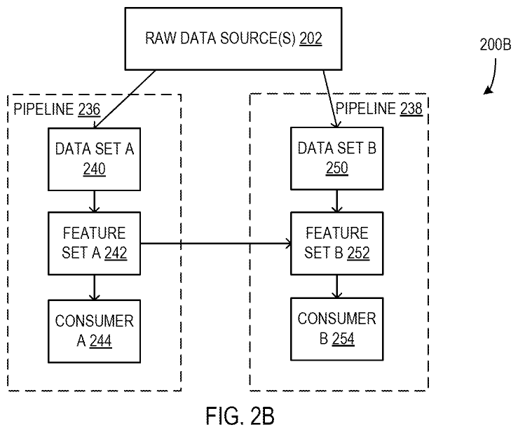

Additionally, or alternatively, the job scheduler 126 is configured to schedule the execution of feature creators on the feature creation resources 112 based at least in part on the resources consumed by the processes of those feature creators. For example, if several feature creators consume relatively small quantities of resources 112 and do not depend on one another, the job scheduler 126 schedules those several feature creators to be executed using the resources 112 at the same time, in parallel, to the extent that there are sufficient resources to do so. For example, five “lightweight” feature creator processes are executed in parallel based on the quantity of available resources. In other examples, if a feature creator consumes relatively large quantities of resources 112, the job scheduler 126 is configured to execute that feature creator alone or at least with fewer parallel processes to avoid overloading the resources 112 or negatively affecting the efficiency of the system 100. The scheduling of operations by the data service 104 and feature creation resources 112 are illustrated in greater detail herein with respect to FIGS. 2A-B.

FIGS. 2A-B are diagrams illustrating differences between a system 200A in which ML pipelines are processed separately and a system 200B as described in FIG. 1. In system 200A of FIG. 2A, raw data sources 202 provide data sets for use by two pipelines 236 and 238. In some examples, the pipelines are ML pipelines. During the processing of the pipeline 236, a data set A 240 (e.g., a raw data set 111) is obtained from the raw data sources 202, a feature set A 242 (e.g., a feature set 121) is created from the data set A 240, and the feature set A 242 is consumed by a consumer A 244 (e.g., a feature consumer 130, 132, or 134).

During the processing of pipeline 238, data sets A 246 and B 250 are obtained from the raw data sources 202, a feature set A 248 is created using data set A 246, a feature set B 252 is created using data set B 250 and feature set A 248, and the feature set B 252 is consumed by consumer B 254. Pipeline 238 requires the use of the same data set A and feature set A as is used in pipeline 236. However, because each pipeline is processed separately in the system 200A, the effort of obtaining data set A and creating feature set A from data set A is duplicated in the two pipelines, resulting in inefficient use of system resources and time.

In contrast, in system 200B of FIG. 2B, the raw data sources 202 provide the data set A 240 to the pipeline 236, as described above with respect to system 200A. Further, the raw data sources 202 provide the data set B 250 to the pipeline 238. However, because the data set A 240 has already been provided to the pipeline 236, the process is not duplicated with pipeline 238 because the processing of both pipelines is being managed by the system 200B (e.g., using a feature service 122 and an associated dependency graph 124 and job scheduler 126).

The feature set A 242 is created in the pipeline 236 and the consumer A 244 consumes the feature set A 242 as described above. Then, when the feature set A 242 is created, the pipeline 238 can continue by creating feature set B 252 using the data set B 250 and the feature set A 242 that was created in pipeline 236, thus avoiding duplication of the effort and/or data storage consumption to create a feature set A 248 for pipeline 238 as in system 200A above. The feature set B 252 is then consumed by consumer B 254.

It should be understood that, while the raw data caches and feature caches are not illustrated in FIGS. 2A-B, in some examples, the systems 200A and 200B include such caches to store raw data sets and feature sets as described elsewhere. In examples where system 200B includes such caches, the data stored in the caches are shared across the pipelines 236 and 238, which enables the avoidance of duplicated effort and increases the efficiency of the system 200B.

In some examples, the operations of the pipelines 236 and 238 are scheduled in the system 200B based on a dependency graph, such as dependency graph 124, as described above. For example, the dependencies in the dependency graph of system 200B indicate that consumer A is dependent on feature set A and consumer B is dependent on feature set B. Further, feature set B is dependent on data set B and feature set A, while feature set A is dependent on data set A. By analyzing these dependencies, the system 200B is enabled to schedule the processes for obtaining the data sets from the sources 202 and for executing feature creators to create the features sets. In an example where the system 200B is configured as illustrated, the system 200B schedules the process to obtain the data set A first. Data set A is required to create feature set A and feature set B requires feature set A to be executed. Data set A can immediately be used to start executing the feature creator process to create feature set A, so it should be obtained first.

Once data set A is obtained, the system 200B schedules the execution of the feature creator to create feature set A. All the dependencies for that process are available, so it is scheduled. Further, in examples where the system 200B uses different resources to obtain data sets and to execute feature creators (e.g., a data service 104 and feature creation resources 112), the system 200B also schedules the process for obtaining data set B from the raw data sources. Because they do not depend on each other, the processes for creating the feature set A and obtaining the data set B can be performed at the same time, in parallel. Alternatively, in some examples, the system 200B is able to obtain both data set A and data set B at substantially the same time. In some examples, the system 200B does so, such that data set B is already available when the feature set A is being created. After feature set A is created and data set B is obtained, the system 200B schedules the feature set B to be created.

It should be understood that, in some examples, the system 200B schedules or queues the operations of the pipelines 236 and 238 based on the dependency graph of the system 200B, such that the full schedule is established and the resources of the system 200B are used to perform operations based on the established schedule. When a scheduled operation is complete, the next operation is performed. Additionally, or alternatively, the schedule reflects the dependencies for each operation, such that an operation for which some data dependency is not available does not execute until the data dependency becomes available. In some examples, the schedule of operations is defined in such a way that idle time for system resources is avoided to the extent that it is possible, so while one operation is waiting on dependencies, another operation is executed using those system resources.

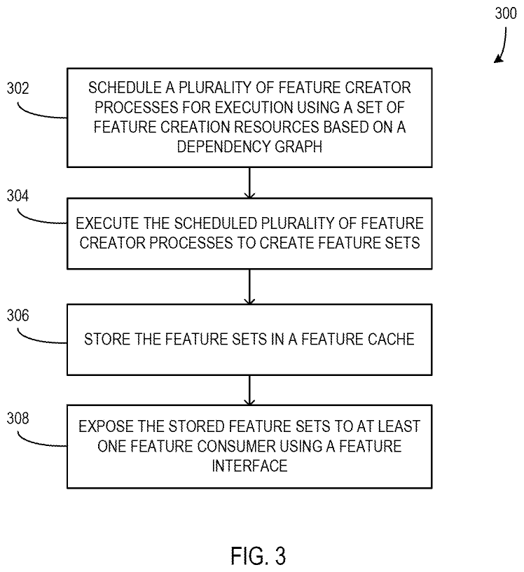

FIG. 3 is a flowchart illustrating a method 300 for managing the execution of ML pipelines in a system (e.g., system 100) based on a dependency graph (e.g., dependency graph 124). In some examples, the method 300 is executed or otherwise performed by or in a system such as system 100 of FIG. 1.

At 302, a plurality of feature creator processes are scheduled for execution using a set of feature creation resources based at least in part on a dependency graph. In some examples, scheduling the feature creator processes includes determining a first feature creator process that is dependent on a second feature creator process and scheduling the first feature creator process to be executed before the second feature creator process. Further, in some examples, scheduling the feature creator processes includes determining multiple processes that do not depend on each other and that can be executed in parallel using the feature creation resources and then scheduling those determined multiple processes to be executed in parallel.

Additionally, or alternatively, in some examples, scheduling the plurality of feature creator processes includes scheduling raw data sets upon which the processes depend to be obtained and stored in a raw data cache. For example, the data service 104 is scheduled to obtain raw data sets 111 and store them in the raw data caches 110 based on the dependency graph.

Further, in some examples, a feature set created by a first feature creator process is to be used by both of a second feature creator process and a third feature creator process. In some examples, the first feature creator process is scheduled to execute before either the second or third feature creator process, and the created feature set is then provided to both the second and third feature creator processes when they are executed. Thus, the first feature creator process is executed to create one instance of the feature set which is then shared by the second and third feature creator processes, such that the effort and computing resource consumption of creating the feature set is not duplicated for the second and third feature creator processes.

At 304, the scheduled plurality of feature creator processes is executed to create feature sets. In some examples, the feature creator processes are scheduled to be executed at specific times and, in such examples, the feature creator processes are executed at those times. Alternatively, or additionally, in some examples, a first feature creator process is scheduled to be executed after a second feature creator process. Once it is determined that the second feature creator process has finished executing, the first feature creator process is executed, regardless of the specific time. Further, in some examples, the execution of the first feature creator process is delayed based at least in part on the system having insufficient available feature creation resources. In such cases, the first feature creator process is executed when a sufficient quantity and/or type of resources become available.

At 306, the features sets (e.g., feature sets 121) are stored in a feature cache (e.g., feature caches 120). In some examples, the feature sets are stored in the feature cache as they are being created, such that the execution of all of the plurality of feature creator processes is not complete when the first feature sets are stored in the feature cache. Further, in some examples, some of the plurality of feature creator processes depend on feature sets that are stored in the feature cache, such that they are not executed until the associated feature sets are stored in the feature cache and become available to them.

At 308, the stored feature sets are exposed to at least one feature consumer using a feature interface (e.g., the feature interface 128 or another API). In some examples, the feature interface provides feature consumers with the feature sets in the feature cache based on requests from the consumers. Alternatively, or additionally, the feature interface is configured to enable the feature consumers to access the feature cache to obtain desired feature sets. Further, in some examples, the feature interface is configured to secure access to the feature sets by the feature consumers such that only consumers that are intended to access a feature set are enabled to do so. This security may be enforced through granting privileges to accounts or profiles of feature consumers, though other methods are used in other examples without departing from the description.

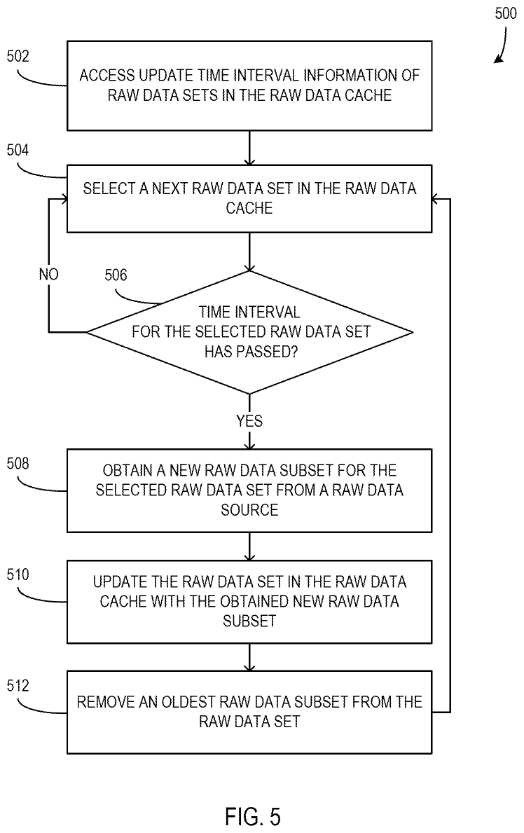

Additionally, or alternatively, in some examples, scheduling the execution of the plurality of feature creator processes includes scheduling a feature creator process to be executed periodically or otherwise repeatedly. In some examples, the feature creator process is scheduled repeatedly based at least in part on a scheduled update of a raw data set on which the feature creator process depends, thus causing the feature creator process to create updated feature sets when the associated raw data set is updated with new data. The updating of the raw data sets is described in greater detail below with respect to FIG. 5.

Further, in some examples, the feature creator processes include at least one of the following: feature creator processes configured to create feature sets by filtering data values out of raw data sets; feature creator processes configured to create feature sets by combining data values of raw data sets into aggregate values; feature creator processes configured to create feature sets based at least in part on other created feature sets; and feature creator process configured to create feature sets by applying an ML model to raw data sets.

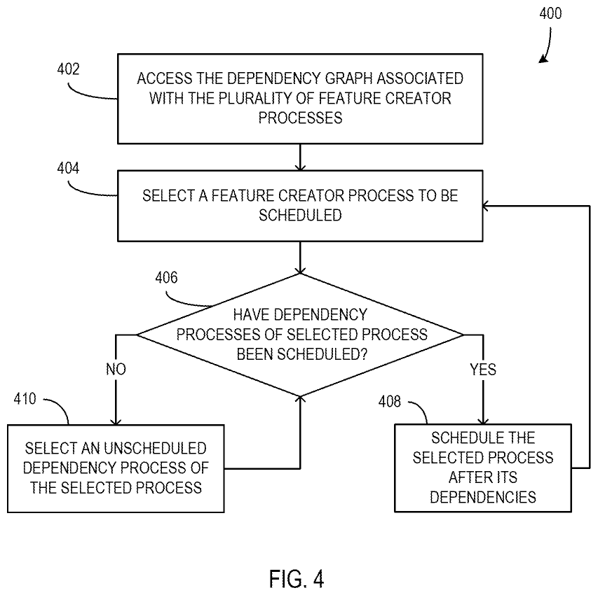

FIG. 4 is a flowchart illustrating a method 400 for scheduling the execution of feature creator processes in a system based on a dependency graph. In some examples, the method 400 is executed or otherwise performed as part of the method 300 of FIG. 3. Further, in some examples, the method 400 is executed or otherwise performed by or in a system such as system 100 of FIG. 1.

At 402, the dependency graph associated with the plurality of feature creator processes is accessed and, at 404, a feature creator process that is yet to be scheduled is selected from the plurality of feature creator processes. In some examples, selecting the feature creator process at 404 is done randomly or pseudo-randomly. Alternatively, or additionally, the feature creator process is selected based at least in part on the most recently scheduled process (e.g., a process that depends on the most recently scheduled process is selected). In other examples, other methods of selecting the feature creator process at 404 are used without departing from the description.

At 406, if dependency processes of the selected process have been scheduled, the process proceeds to 408. Alternatively, if dependency processes of the selected process have not been scheduled, the process proceeds to 410. Dependency processes of the selected process include processes upon which the selected process depends based on the data in the dependency graph. In most examples, the dependency processes of the selected process must be executed prior to execution of the selected process to ensure that feature sets and/or other associated data that are required for the selected process are available when the selected process executes.

At 408, the selected process is scheduled after its dependencies. In some examples, the schedule includes an order in which the processes are to be executed, and because the dependency processes of the selected process have already been scheduled, the selected process should be scheduled after them. For example, the schedule of processes includes a queue and processes are scheduled by adding them to the end of the queue. When the scheduled processes are executed, they are executed from the front of the queue, such that they are executed in the order in which they are added to the queue. In other examples, other arrangements of scheduled processes are used without departing from the description.

At 410, an unscheduled dependency process of the selected process is selected. Thus, the selected unscheduled dependency process becomes the selected process for the purposes of the method 400. The process then returns to 406 to check if the dependency processes of the newly selected process have been scheduled. In this manner, a loop between 406 and 410 causes the method 400 to ‘climb’ the dependency graph to find feature creator processes for which all dependency processes have been scheduled and then schedule those processes.

FIG. 5 is a flowchart illustrating a method 500 for maintaining up-to-date raw data sets (e.g., raw data sets 111) in a raw data cache (e.g., raw data caches 110) using update time intervals (e.g., time intervals tracked in the update schedule 108). In some examples, the method 500 is executed or otherwise performed as part of the method 300 of FIG. 3. Further, in some examples, the method 400 is executed or otherwise performed by or in a system such as system 100 of FIG. 1.

At 502, update time interval information of the raw data sets in the raw data cache is accessed and, at 504, a next raw data set in the raw data cache is selected.

At 506, if an update time interval for the selected raw data set has passed based at least in part on the accessed update time interval information, the process proceeds to 508. Alternatively, if the updated time interval for the selected raw data set has not passed, the process returns to 504 to select the next raw data set in the raw data cache.

At 508, a new raw data subset for the selected raw data set is obtained from a raw data source and, at 510, the raw data set is updated in the raw data cache with the obtained new raw data subset. At 512, an oldest raw data subset is removed from the raw data set in the raw data cache.

In some examples, the update time interval of a raw data set is configured to maintain a constant quantity of data in the raw data set while updating that data over time. A raw data set may include 30 days' worth of data, and it is updated with new data every day. In such an example, the method 500 determines that the day-long time interval has passed for the raw data set at 506 and then obtains one day's worth of new data from the raw data source. That new data subset with one day's worth of data is included in the raw data set in the raw data cache and a subset of data in the raw data set that includes the oldest day's worth of data is removed.

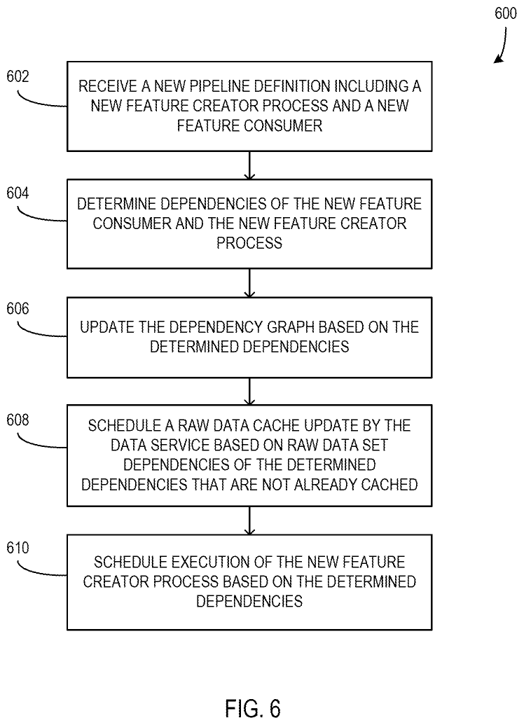

FIG. 6 is a flowchart illustrating a method 600 for updating a system (e.g., a system 100) to include a new ML pipeline. In some examples, the method 600 is executed or otherwise performed as part of the method 300 of FIG. 3. Further, in some examples, the method 400 is executed or otherwise performed by or in a system such as system 100 of FIG. 1.

At 602, a new pipeline definition is received, including a new feature creator process and a new feature consumer. In some examples, the new pipeline definition further includes dependency information regarding raw data sets and/or feature sets. Additionally, or alternatively, in some examples, the new pipeline definition includes information associated multiple feature consumers and/or multiple feature creator processes without departing from the description.

At 604, dependencies of the new feature consumer and the new feature creator process are determined and, at 606, the dependency graph is updated based on the determined dependencies. In some examples, determining dependencies includes determining raw data sets and/or feature sets that are not currently present in the system as well as determining raw data sets and/or feature sets that are already in the system and in use by other pipelines.

At 608, a raw data cache update is scheduled based on raw data set dependencies of the determined dependencies that are not already cached. In some examples, the raw data sets required by the new feature creator process as determined at 604 are compared to the raw data sets that are currently in the raw data cache (e.g., using cached data set data 106). Any raw data sets that are not already present are then scheduled to be obtained by the data service 104 as described herein. In some such examples, the data service 104 is configured to keep the newly obtained raw data sets up to date in the raw data cache as described herein.

At 610, execution of the new feature creator process is scheduled based on the determined dependencies. In some examples, the new feature creator process is scheduled to be executed after any dependency feature creator process in the schedule. Further, in some examples, the new feature creator process is scheduled to be executed in parallel with one or more other feature creator processes based at least in part on the availability of feature creation resources during that execution period. Additionally, or alternatively, the new feature creator process is scheduled to be executed periodically or otherwise repeatedly. For example, the schedule is based at least in part on an update time interval of at least one raw data set upon which the new feature creator process depends.

### Exemplary Operating Environment

The present disclosure is operable with a computing apparatus according to an embodiment as a functional block diagram 700 in FIG. 7. In an example, components of a computing apparatus 718 are implemented as a part of an electronic device according to one or more embodiments described in this specification. The computing apparatus 718 comprises one or more processors 719 which may be microprocessors, controllers, or any other suitable type of processors for processing computer executable instructions to control the operation of the electronic device. Alternatively, or in addition, the processor 719 is any technology capable of executing logic or instructions, such as a hardcoded machine. In some examples, platform software comprising an operating system 720 or any other suitable platform software is provided on the apparatus 718 to enable application software 721 to be executed on the device. In some examples, scheduling or otherwise managing execution of ML pipelines based on dependency graphs as described herein is accomplished by software, hardware, and/or firmware.

In some examples, computer executable instructions are provided using any computer-readable media that are accessible by the computing apparatus 718. Computer-readable media include, for example, computer storage media such as a memory 722 and communications media. Computer storage media, such as a memory 722, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 722) is shown within the computing apparatus 718, it will be appreciated by a person skilled in the art, that, in some examples, the storage is distributed or located remotely and accessed via a network or other communication link (e.g., using a communication interface 723).

Further, in some examples, the computing apparatus 718 comprises an input/output controller 724 configured to output information to one or more output devices 725, for example a display or a speaker, which are separate from or integral to the electronic device. Additionally, or alternatively, the input/output controller 724 is configured to receive and process an input from one or more input devices 726, for example, a keyboard, a microphone, or a touchpad. In one example, the output device 725 also acts as the input device. An example of such a device is a touch sensitive display. The input/output controller 724 may also output data to devices other than the output device, e.g., a locally connected printing device. In some examples, a user provides input to the input device(s) 726 and/or receive output from the output device(s) 725.

The functionality described herein can be performed, at least in part, by one or more hardware logic components. According to an embodiment, the computing apparatus 718 is configured by the program code when executed by the processor 719 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system comprises: at least one processor; and at least one memory comprising computer program code, the at least one memory and the computer program code configured to, with the at least one processor, cause the at least one processor to: schedule a plurality of feature creator processes for execution using a set of feature creation resources, wherein the scheduling is based at least in part on a dependency graph which describes dependency relationships between the plurality of feature creator processes and raw data sets stored in a raw data cache; execute the scheduled plurality of feature creator processes using the set of feature creation resources, wherein feature sets are created from the executed plurality of feature creator processes; store the feature sets in a feature cache; and expose the stored features sets in the feature cache to at least one feature consumer using a feature interface.

An example computerized method comprises: scheduling a plurality of feature creator processes for execution using a set of feature creation resources, wherein the scheduling is based at least in part on a dependency graph which describes dependency relationships between the plurality of feature creator processes and raw data sets stored in a raw data cache; executing the scheduled plurality of feature creator processes using the set of feature creation resources, wherein feature sets are created from the executed plurality of feature creator processes; storing the feature sets in a feature cache; and exposing the stored features sets in the feature cache to at least one feature consumer using a feature interface.

One or more computer storage media have computer-executable instructions that, upon execution by a processor, cause the processor to at least: schedule a plurality of feature creator processes for execution using a set of feature creation resources, wherein the scheduling is based at least in part on a dependency graph which describes dependency relationships between the plurality of feature creator processes and raw data sets stored in a raw data cache; execute the scheduled plurality of feature creator processes using the set of feature creation resources, wherein feature sets are created from the executed plurality of feature creator processes; store the feature sets in a feature cache; and expose the stored features sets in the feature cache to at least one feature consumer using a feature interface.

Alternatively, or in addition to the other examples described herein, examples include any combination of the following:
wherein scheduling execution of the plurality of feature creator processes includes: scheduling a first feature creator process in a first time interval, wherein the dependency graph indicates that the first feature creator process is dependent on a raw data set stored in the raw data cache; and scheduling a second feature creator process in a second time interval, wherein the dependency graph indicates that the second feature creator process is dependent on the first feature creator process, and wherein the second time interval is after the first time interval; and wherein executing the scheduled plurality of feature creator processes includes: executing the first feature creator process using at least the raw data set to create a first feature set of the feature sets during the first time interval; and executing the second feature creator process using at least the first feature set to create a second feature set of the feature sets during the second time interval.
further comprising: determining an update time interval of a raw data set in the raw data cache has passed; obtaining a new raw data subset associated with the determined update time interval from a raw data source; updating the raw data set in the raw data cache with the obtained new raw data subset; and removing an oldest raw data subset from the raw data set, wherein the oldest raw data subset includes data associated with an oldest time interval that is as long as of the update time interval.
wherein scheduling the execution of the plurality of feature creator processes includes: determining that a feature creator process of the plurality of feature creator processes is dependent on the raw data set according to the dependency graph; and scheduling the determined feature creator process for execution repeatedly based at least in part on the update time interval of the raw data set, whereby the determined feature creator process is executed after the raw data set is updated in the raw data cache.
wherein executing the scheduled plurality of feature creator processes using the set of feature creation resources includes: determining that the set of feature creation resources includes sufficient resources to execute at least two feature creator processes in parallel; and executing the at least two feature creator processes in parallel, wherein the at least two feature creator processes executed in parallel do not depend on each other according to the dependency graph.
further comprising: determining a raw data set from a raw data source upon which at least two feature creator processes of the plurality of feature creator processes depend based at least in part on the dependency graph; and storing one instance of the determined raw data set to the raw data cache from the raw data source for use by the at least two feature creator processes.
wherein the plurality of feature creator processes include at least one of the following: feature creator processes configured to create feature sets by filtering data values out of raw data sets; feature creator processes configured to create feature sets by combining data values of raw data sets into aggregate values; feature creator processes configured to create feature sets based at least in part on other created feature sets; and feature creator process configured to create feature sets by applying an ML model to raw data sets.

Any range or device value given herein may be extended or altered without losing the effect sought, as will be apparent to the skilled person.

Examples have been described with reference to data monitored and/or collected from the users (e.g., user identity data with respect to profiles). In some examples, notice is provided to the users of the collection of the data (e.g., via a dialog box or preference setting) and users are given the opportunity to give or deny consent for the monitoring and/or collection. The consent takes the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute an exemplary means for scheduling a plurality of feature creator processes for execution using a set of feature creation resources, wherein the scheduling is based at least in part on a dependency graph which describes dependency relationships between the plurality of feature creator processes and raw data sets stored in a raw data cache; exemplary means for executing the scheduled plurality of feature creator processes using the set of feature creation resources, wherein feature sets are created from the executed plurality of feature creator processes; exemplary means for storing the feature sets in a feature cache; and exemplary means for exposing the stored features sets in the feature cache to at least one feature consumer using a feature interface.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a processor; and
a memory comprising computer program code, the memory and the computer program code configured to, with the processor, cause the processor to:
schedule a plurality of feature creator processes for execution using a set of feature creation resources, wherein the scheduling is based at least in part on a dependency graph which describes dependency relationships between the plurality of feature creator processes and raw data sets stored in a raw data cache;
execute the scheduled plurality of feature creator processes using the set of feature creation resources, wherein feature sets are created from the executed plurality of feature creator processes;
store the feature sets in a feature cache; and
provide the stored features sets in the feature cache to a feature consumer using a feature interface.

2. The system of claim 1, wherein scheduling execution of the plurality of feature creator processes includes:
scheduling a first feature creator process in a first time interval, wherein the dependency graph indicates that the first feature creator process is dependent on a raw data set stored in the raw data cache; and
scheduling a second feature creator process in a second time interval, wherein the dependency graph indicates that the second feature creator process is dependent on the first feature creator process, and wherein the second time interval is after the first time interval; and
wherein executing the scheduled plurality of feature creator processes includes:
executing the first feature creator process using at least the raw data set to create a first feature set of the feature sets during the first time interval; and
executing the second feature creator process using at least the first feature set to create a second feature set of the feature sets during the second time interval.

3. The system of claim 1, wherein the memory and the computer program code is configured to, with the processor, further cause the processor to:
determine an update time interval of a raw data set in the raw data cache has passed;
obtain a new raw data subset associated with the determined update time interval from a raw data source;
update the raw data set in the raw data cache with the obtained new raw data subset; and
remove an oldest raw data subset from the raw data set, wherein the oldest raw data subset includes data associated with an oldest time interval that is as long as of the update time interval.

4. The system of claim 3, wherein scheduling the execution of the plurality of feature creator processes includes:
determining that a feature creator process of the plurality of feature creator processes is dependent on the raw data set according to the dependency graph; and
scheduling the determined feature creator process for execution repeatedly based at least in part on the update time interval of the raw data set, whereby the determined feature creator process is executed after the raw data set is updated in the raw data cache.

5. The system of claim 1, wherein executing the scheduled plurality of feature creator processes using the set of feature creation resources includes:
determining that the set of feature creation resources includes sufficient resources to execute at least two feature creator processes in parallel; and
executing the at least two feature creator processes in parallel, wherein the at least two feature creator processes executed in parallel do not depend on each other according to the dependency graph.

6. The system of claim 1, wherein the memory and the computer program code is configured to, with the processor, further cause the processor to:
determine a raw data set from a raw data source upon which at least two feature creator processes of the plurality of feature creator processes depend based at least in part on the dependency graph; and
store one instance of the determined raw data set to the raw data cache from the raw data source for use by the at least two feature creator processes.

7. The system of claim 1, wherein the plurality of feature creator processes include at least one of the following: feature creator processes configured to create feature sets by filtering data values out of raw data sets; feature creator processes configured to create feature sets by combining data values of raw data sets into aggregate values; feature creator processes configured to create feature sets based at least in part on other created feature sets; and feature creator process configured to create feature sets by applying a machine learning model to raw data sets.

8. A computerized method comprising:
scheduling a plurality of feature creator processes for execution using a set of feature creation resources, wherein the scheduling is based at least in part on a dependency graph which describes dependency relationships between the plurality of feature creator processes and raw data sets stored in a raw data cache;
executing the scheduled plurality of feature creator processes using the set of feature creation resources, wherein feature sets are created from the executed plurality of feature creator processes;
storing the feature sets in a feature cache; and
providing the stored features sets in the feature cache to a feature consumer using a feature interface.

9. The computerized method of claim 8, wherein scheduling execution of the plurality of feature creator processes includes:
scheduling a first feature creator process in a first time interval, wherein the dependency graph indicates that the first feature creator process is dependent on a raw data set stored in the raw data cache; and
scheduling a second feature creator process in a second time interval, wherein the dependency graph indicates that the second feature creator process is dependent on the first feature creator process, and wherein the second time interval is after the first time interval; and
wherein executing the scheduled plurality of feature creator processes includes:
executing the first feature creator process using at least the raw data set to create a first feature set of the feature sets during the first time interval; and
executing the second feature creator process using at least the first feature set to create a second feature set of the feature sets during the second time interval.

10. The computerized method of claim 8, further comprising:
determining an update time interval of a raw data set in the raw data cache has passed;
obtaining a new raw data subset associated with the determined update time interval from a raw data source;
updating the raw data set in the raw data cache with the obtained new raw data subset; and
removing an oldest raw data subset from the raw data set, wherein the oldest raw data subset includes data associated with an oldest time interval that is as long as of the update time interval.

11. The computerized method of claim 10, wherein scheduling the execution of the plurality of feature creator processes includes:
determining that a feature creator process of the plurality of feature creator processes is dependent on the raw data set according to the dependency graph; and
scheduling the determined feature creator process for execution repeatedly based at least in part on the update time interval of the raw data set, whereby the determined feature creator process is executed after the raw data set is updated in the raw data cache.

12. The computerized method of claim 8, wherein executing the scheduled plurality of feature creator processes using the set of feature creation resources includes:
determining that the set of feature creation resources includes sufficient resources to execute at least two feature creator processes in parallel; and
executing the at least two feature creator processes in parallel, wherein the at least two feature creator processes executed in parallel do not depend on each other according to the dependency graph.

13. The computerized method of claim 8, further comprising:
determining a raw data set from a raw data source upon which at least two feature creator processes of the plurality of feature creator processes depend based at least in part on the dependency graph; and
storing one instance of the determined raw data set to the raw data cache from the raw data source for use by the at least two feature creator processes.

14. The computerized method of claim 8, wherein the plurality of feature creator processes include at least one of the following: feature creator processes configured to create feature sets by filtering data values out of raw data sets; feature creator processes configured to create feature sets by combining data values of raw data sets into aggregate values; feature creator processes configured to create feature sets based at least in part on other created feature sets; and feature creator process configured to create feature sets by applying a machine learning model to raw data sets.

15. A computer storage medium having computer-executable instructions that, upon execution by a processor, cause the processor to at least:
schedule a plurality of feature creator processes for execution using a set of feature creation resources, wherein the scheduling is based at least in part on a dependency graph which describes dependency relationships between the plurality of feature creator processes and raw data sets stored in a raw data cache;
execute the scheduled plurality of feature creator processes using the set of feature creation resources, wherein feature sets are created from the executed plurality of feature creator processes;
store the feature sets in a feature cache; and
provide the stored features sets in the feature cache to a feature consumer using a feature interface.

16. The computer storage medium of claim 15, wherein scheduling execution of the plurality of feature creator processes includes:
scheduling a first feature creator process in a first time interval, wherein the dependency graph indicates that the first feature creator process is dependent on a raw data set stored in the raw data cache; and
scheduling a second feature creator process in a second time interval, wherein the dependency graph indicates that the second feature creator process is dependent on the first feature creator process, and wherein the second time interval is after the first time interval; and
wherein executing the scheduled plurality of feature creator processes includes:
executing the first feature creator process using at least the raw data set to create a first feature set of the feature sets during the first time interval; and
executing the second feature creator process using at least the first feature set to create a second feature set of the feature sets during the second time interval.

17. The computer storage medium of claim 15, wherein the computer-executable instructions, upon execution by a processor, further cause the processor to at least:
determine an update time interval of a raw data set in the raw data cache has passed;
obtain a new raw data subset associated with the determined update time interval from a raw data source;
update the raw data set in the raw data cache with the obtained new raw data subset; and
remove an oldest raw data subset from the raw data set, wherein the oldest raw data subset includes data associated with an oldest time interval that is as long as of the update time interval.

18. The computer storage medium of claim 17, wherein scheduling the execution of the plurality of feature creator processes includes:
determining that a feature creator process of the plurality of feature creator processes is dependent on the raw data set according to the dependency graph; and
scheduling the determined feature creator process for execution repeatedly based at least in part on the update time interval of the raw data set, whereby the determined feature creator process is executed after the raw data set is updated in the raw data cache.

19. The computer storage medium of claim 15, wherein executing the scheduled plurality of feature creator processes using the set of feature creation resources includes:
determining that the set of feature creation resources includes sufficient resources to execute at least two feature creator processes in parallel; and
executing the at least two feature creator processes in parallel, wherein the at least two feature creator processes executed in parallel do not depend on each other according to the dependency graph.

20. The computer storage medium of claim 15, wherein the computer-executable instructions, upon execution by a processor, further cause the processor to at least:
determine a raw data set from a raw data source upon which at least two feature creator processes of the plurality of feature creator processes depend based at least in part on the dependency graph; and
store one instance of the determined raw data set to the raw data cache from the raw data source for use by the at least two feature creator processes.
